(19) United States
(12) Patent Application Publication
(10) Pub. No.: US 2025/0329091 A1
(43) Pub. Date: Oct. 23, 2025

(54) DYNAMIC MOTION OF A VIRTUAL MEETING PARTICIPANT VISUAL REPRESENTATION TO INDICATE AN ACTIVE SPEAKER

(71) Applicant: Google LLC, Mountain View, CA (US)

(72) Inventors: Kelly Leigh Dern, Boulder, CO (US); Avery Daniel Wilson Fisher, San Francisco, CA (US); Justin Volz, Oakland, CA (US); Karsten Seipp, East Harling (GB)

(21) Appl. No.: 18/637,730

(22) Filed: Apr. 17, 2024

(51) Int. Cl. G06T 13/40; H04N 7/15

(52) U.S. Cl. CPC G06T 13/40; H04N 7/157

(57) ABSTRACT

A method includes causing a virtual meeting UI to be presented during a virtual meeting between participants. The virtual meeting UI includes a first region corresponding to a first participant and includes a first visual representation having a first visual characteristic associated with first participant data of the first participant. The method includes determining that the first participant is a current speaker of the virtual meeting and animating the first visual representation. The method includes determining, while the first participant is speaking, that the first participant data has changed and determining, based on the changed first participant data, a second visual characteristic for the first visual representation. The method includes causing the first visual representation to be animated to have the second visual characteristic to indicate that the first participant is the current speaker of the virtual meeting and that the first participant data has changed.

### TECHNICAL FIELD

Aspects and implementations of the present disclosure relate to virtual meetings and more specifically relate to using dynamic motion of a virtual meeting participant visual representation to indicate an active speaker.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method. The method may include a method for using dynamic motion of a virtual meeting participant visual representation to indicate an active speaker. The method may include causing a virtual meeting user interface (UI) to be presented during a virtual meeting between one or more participants. The virtual meeting UI may include one or more regions, and each region can correspond to a participant. The one or more regions may include a first region that corresponds to a first participant. The first region may include a first visual representation including an avatar of the first participant, and the first visual representation may include a first visual characteristic associated with first participant data. The method may include determining that the first participant is a current speaker of the virtual meeting. The method may include animating the first visual representation to indicate that the first participant is the current speaker of the virtual meeting. The method may include determining, while the first participant is speaking during the virtual meeting, that the first participant data of the first participant has changed. The method may include determining, based on the changed first participant data, a second visual characteristic for the first visual representation. The method may include causing the first visual representation being animated to have the second visual characteristic to indicate that the first participant is the current speaker of the virtual meeting and that the first participant data has changed.

Another aspect of the disclosure provides another method. The method may include a method for using dynamic motion of a virtual meeting participant visual representation to indicate an active speaker. The method may include causing a virtual meeting UI to be presented during a virtual meeting between one or more participants. The virtual meeting UI may include one or more regions, and each region can correspond to a participant. The one or more regions may include a first region that corresponds to a first participant. The first region may include a first visual representation including an avatar of the first participant, and the first visual representation may include a first visual characteristic associated with an audio characteristic of the first participant. The method may include determining that the first participant is a current speaker of the virtual meeting. The method may include animating the first visual representation to indicate that the first participant is the current speaker of the virtual meeting. The method may include determining, while the first participant is speaking during the virtual meeting, that the audio characteristic of the first participant has changed. The method may include determining, based on the changed audio characteristic, a second visual characteristic for the first visual representation. The method may include causing the first visual representation being animated to have the second visual characteristic to indicate that the first participant is the current speaker of the virtual meeting and that the audio characteristic has changed.

Another aspect of the disclosure provides another method. The method may include a method for using dynamic motion of a virtual meeting participant visual representation to indicate an active speaker. The method may include causing a virtual meeting UI to be presented during a virtual meeting between one or more participants. The virtual meeting UI may include one or more regions, and each region can correspond to a participant. The one or more regions may include a first region that corresponds to a first participant. The first region may include a first visual representation including an avatar of the first participant, and the first visual representation may include a first visual characteristic associated with a camera configuration of a client device of the first participant. The method may include determining that the first participant is a current speaker of the virtual meeting. The method may include animating the first visual representation to indicate that the first participant is the current speaker of the virtual meeting. The method may include determining, while the first participant is speaking during the virtual meeting, that the camera configuration of the client device of the first participant has changed. The method may include determining, based on the changed camera configuration, a second visual characteristic for the first visual representation. The method may include causing the first visual representation being animated to have the second visual characteristic to indicate that the first participant is the current speaker of the virtual meeting and that the camera configuration has changed.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram that illustrates an example system architecture for using dynamic motion of a virtual meeting participant visual representation to indicate an active speaker, in accordance with some implementations of the present disclosure.

FIG. 2 is a flow diagram illustrating an example method for using dynamic motion of a virtual meeting participant visual representation to indicate an active speaker, in accordance with some implementations of the present disclosure.

FIG. 3 is a front view of an example user interface for using dynamic motion of a virtual meeting participant visual representation to indicate an active speaker, in accordance with some implementations of the present disclosure.

FIG. 4 is a front view of an example user interface for using dynamic motion of a virtual meeting participant visual representation to indicate an active speaker, in accordance with some implementations of the present disclosure.

FIG. 5 is a front view of an example user interface for using dynamic motion of a virtual meeting participant visual representation to indicate an active speaker, in accordance with some implementations of the present disclosure.

FIG. 6 is a flow diagram illustrating an example method for using dynamic motion of a virtual meeting participant visual representation to indicate an active speaker, in accordance with some implementations of the present disclosure.

FIG. 7 is a flow diagram illustrating an example method for using dynamic motion of a virtual meeting participant visual representation to indicate an active speaker, in accordance with some implementations of the present disclosure.

FIG. 8 is a block diagram illustrating an example computer system, in accordance with some implementations of the present disclosure.

### DETAILED DESCRIPTION

Aspects of the present disclosure relate to using dynamic motion of a virtual meeting participant visual representation to indicate an active speaker. A virtual meeting platform can enable conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the virtual meeting participants in a set of regions in the UI.

Sometimes, a virtual meeting can be an audio-based virtual meeting. An audio-based virtual meeting may include an audio-only virtual meeting (e.g., when the client devices of all virtual meeting participants provide audio streams created using their respective microphones but not video streams that would be created using their respective cameras). An audio-based virtual meeting may include a virtual meeting with emphasis on audio interaction between participants (e.g., when one or more of the client devices of the one or more virtual meeting participants provide audio streams but not video streams). However, because of the audio-focused nature of the audio-based virtual meeting, it can be difficult for participants to determine information about other participants, such as who is currently speaking, a role of a participant, a group with whom the participant is associated, a location of a participant, or other information. The audio-focused nature of the audio-based virtual meeting can also make it difficult to determine when such information changes. This lack of information about the virtual meeting participants degrades the participants' virtual meeting experience and may lead to the participants using video-based virtual meetings. However, video-based virtual meetings use more bandwidth, need to have a camera attached to or integrated with each client device, and can require more processing device usage (e.g., to perform video-processing operations, which can involve high usage of general-purpose processing devices or graphical processing devices).

Implementations of the present disclosure address the above and other deficiencies by providing a virtual meeting platform for audio-based virtual meetings. The virtual meeting platform can cause a virtual meeting UI to be presented during a virtual meeting between multiple participants. The UI may include multiple regions, and each region can correspond to a participant. Each region may include a visual representation of the corresponding participant (e.g., an image of the participant). The platform can determine that a first participant is currently speaking and can cause the first participant's visual representation to be animated in a certain way (e.g., change outline shapes). The animated visual representation can indicate to other participants of the virtual meeting that the first participant is currently speaking and can indicate other information about the first participant (e.g., a role of the first participant during the virtual meeting or a group with whom the first participant is associated). During the virtual meeting, the information associated with the first participant can change, and the platform can cause the animation of the first participant's visual representation to change to reflect this change in information.

Aspects of the present disclosure provide technical advantages over previous solutions. Aspects of the present disclosure can provide an audio-based virtual meeting that presents data about the virtual meeting participants using dynamically generated animated visual representations and indicates changes in the data using changes to the visual representations. As such, the audio-based virtual meetings of the present disclosure provide functionality of video-based virtual meetings while requiring fewer or no cameras and/or less bandwidth and processor resources being expended on video processing.

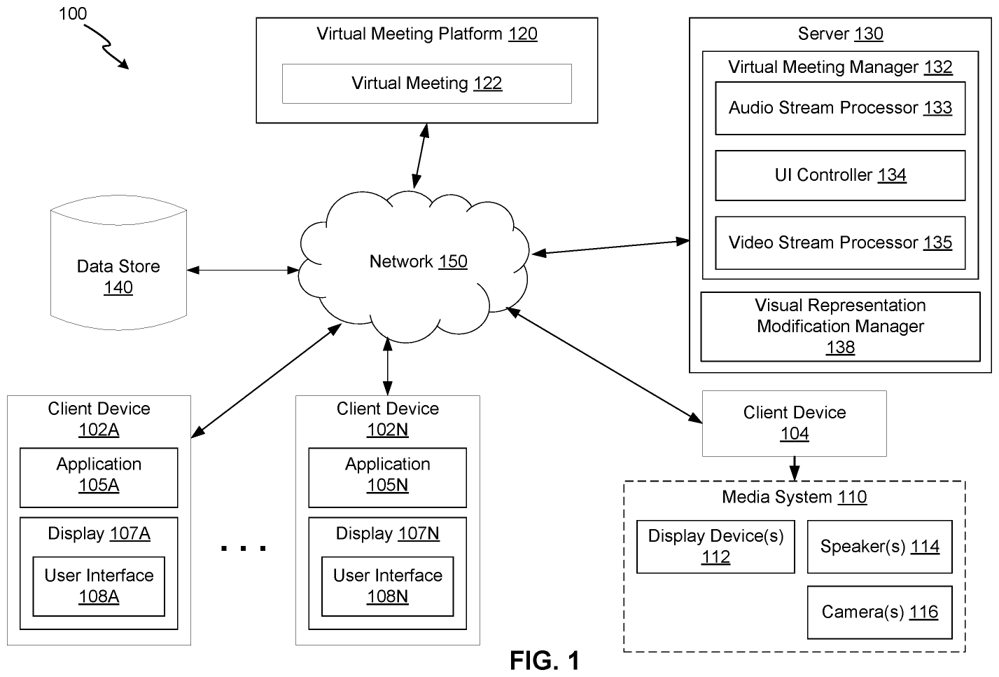

FIG. 1 illustrates an example system architecture 100, in accordance with implementations of the present disclosure. The system architecture 100 includes one or more client devices 102A-102N or 104, a virtual meeting platform 120, a server 130, and a data store 140, each connected to a network 150.

In some implementations, the virtual meeting platform 120 enables users of one or more of the client devices 102A-102N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured to manage a virtual meeting 122 between multiple users of the virtual meeting platform 120. The virtual meeting manager 132 can also collect and provide data associated with the virtual meeting 122 to each participant of the virtual meeting 122. In some implementations, the virtual meeting manager 132 includes an audio stream processor 133, a UI controller 134, and/or a video stream processor 135. Each of the audio stream processor 133, the UI controller 134, and/or the video stream processor 135 may include a software application (or a subset thereof) that performs certain virtual meeting functionality for the virtual meeting manager 132.

The audio stream processor 133 can be configured to receive audio streams from one or more of the client devices 102A-N, 104. The audio stream processor 133 can be configured to determine from which client device 102A-N, 104 a specific audio stream was obtained. The audio stream processor 133 can be configured to determine one or more characteristics, features, etc. of the audio stream.

In some implementations, the UI controller 134 provides the UI 108A-N for the virtual meeting 122. The UI controller 134 can provide the UIs 108A-108N to each client device 102A-N, 104 to enable users to listen to each other or watch each other during a virtual meeting 122. The UI controller 134 can provide the UIs 108A-108N for presentation by client applications 105A-N. For example, the respective UIs 108A-108N can be displayed on the display devices 107A-107N by the client applications 105A-N executing on the operating systems of the client devices 102A-102N, 104.

In some implementations, the UI controller 134 determines visual items for presentation in the UIs 108A-108N during a virtual meeting 122. A visual item can refer to a UI element that occupies a particular region in the UI 108A-N. A visual item may include a visual representation that corresponds to a participant of the virtual meeting 122, as explained further below. A visual item may include a document or media content (e.g., video content, one or more images, etc.) being presented during the virtual meeting 122, etc. In response to being notified of the determined visual items for presentation in the UI 108A-108N, the UI controller 134 can transmit a command to one or more client devices 102A-N, 104 causing each determined visual item to be displayed in a region of the UI 108A-N and/or rearranged in the UI 108A-N. The visual items for presentation can be determined based on a current speaker, current presenter, order of the participants joining the virtual meeting 122, list of participants (e.g., alphabetical), etc.

In some implementations, where the virtual meeting 122 is video-enabled, a visual item presents a video stream from a respective client device 102A-N, 104. Such a video stream can depict, for example, a user of the respective client device 102A-N, 104 while the user is participating in the virtual meeting 122 (e.g., speaking, presenting, listening to other participants, watching other participants, etc., at particular moments during the virtual meeting 122), a physical conference or meeting room (e.g., with one or more participants present). The UI controller 134 can control which video stream is to be displayed by providing a command to one or more client devices 102A-102N, 104 that indicates which video stream is to be displayed in which region of the UI 108A-N(along with the received video and audio streams being provided to the client devices 102A-102N, 104).

In one implementation, the video stream processor 135 is configured to receive video streams from one or more of the client devices 102A-102N, 104. The video stream processor 135 can be configured to determine visual items for presentation in the UI 108A-N of such client devices 102A-N, 104 during the virtual meeting 122.

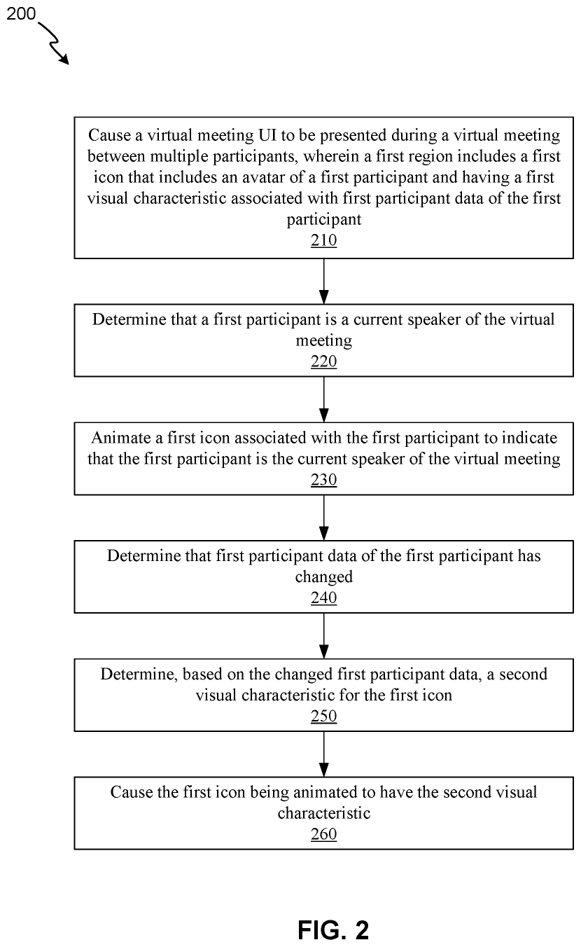

In one or more implementations, the virtual meeting manager 132 includes a visual representation modification manager 138. The visual representation modification manager 138 may include a software application (or a subset thereof) that performs certain virtual meeting functionality for the virtual meeting manager 132. The visual representation modification manager 138 can be configured to select a visual characteristic for a participant's visual representation and cause the animation of the participant's visual representation based on the virtual characteristic. The visual representation modification manager 138 can be configured to change the visual characteristic based on a change in data associated with the respective participant. Functionality of the visual representation modification manager 138 is discussed further below in relation to FIGS. 2, 6, and 7.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-102N each include one or more computing devices such as personal computers (PCs), laptops, mobile phones, smart phones, tablet computers, netbook computers, network-connected televisions, etc. The one or more client devices 102A-102N can also be referred to as “user devices.” Each client device 102A-102N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-102N. In some implementations, the audiovisual component includes an image capture device (e.g., a camera) to capture images and generate video data (e.g., a video stream) of the captured data of the captured images.

In some implementations, the system architecture 100 includes a client device 104. The client device 104 can differ from a client device of the one or more client devices 102A-N because the client device 104 may be associated with a physical conference or meeting room. Such client device 104 can include or be coupled to a media system 110 that can include one or more display devices 112, one or more speakers 114 and one or more cameras 116. Display device 112 can be, for example, a smart display or a non-smart display (e.g., a display that is not itself configured to connect to the network 150). Users that are physically present in the room can use the media system 110 rather than their own devices (e.g., one or more of the client devices 102A-102N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to client devices 102A-102N, the one or more client devices 104 can generate audio and video data to be streamed to the virtual meeting manager 132 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-102N, 104 transmit the generated video stream to the virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-102N, 104 transmit the generated audio data to the virtual meeting manager 132.

In some implementations, each client device 102A-102N or 104 includes a respective client application 105A-N, which can be a mobile application, a desktop application, a web browser, etc. The client application 105A-N can present, on a display device 107-107N of a client device 102A-102N or a UI (e.g., a UI of the UIs 108A-108N), one or more features of the application 105A-N for users to access the virtual meeting platform 120. For example, a user of the client device 102A can join and participate in the virtual meeting 122 via a UI 108A presented on the display device 107A by the application 105A. The user can present a document to participants of the virtual meeting 122 using the UI 108A.

In one or more implementations, the virtual meeting manager 132 (including the visual representation modification manager 138) or just the visual representation modification manager 138 is part of a client device 102A-102N, 104. For example, the application 105A-N can include the visual representation modification manager 138 as part of the virtual meeting manager 132 or by itself. In some implementations, in which the application 105A includes the virtual meeting manager 132, the application 105A sends the audio stream to the other client devices 102B-N, 104, and receives the audio streams from the other client devices 102B-N, 104, and the applications 105A-105N can generate their respective virtual meeting UIs 106A-106N. Alternatively, when the applications 105A-N include some but not all components of the virtual meeting manager 132, the applications 105A-N can finalize their respective UIs 106A-106N, which may have been partially generated by the UI controller 134.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102A-102N, 104 for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-102N, 104 and/or concurrently editable by the users.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102A-N, 104 in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 is a flowchart illustrating one embodiment of a method 200 for using dynamic motion of a virtual meeting participant visual representation to indicate an active speaker, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method's 200 individual functions, routines, subroutines, or operations. In certain implementations, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some implementations, the audio stream processor 133, the UI controller 134, the video stream processor 135, or the visual representation modification manager 138 performs one or more of the operations of the method 200.

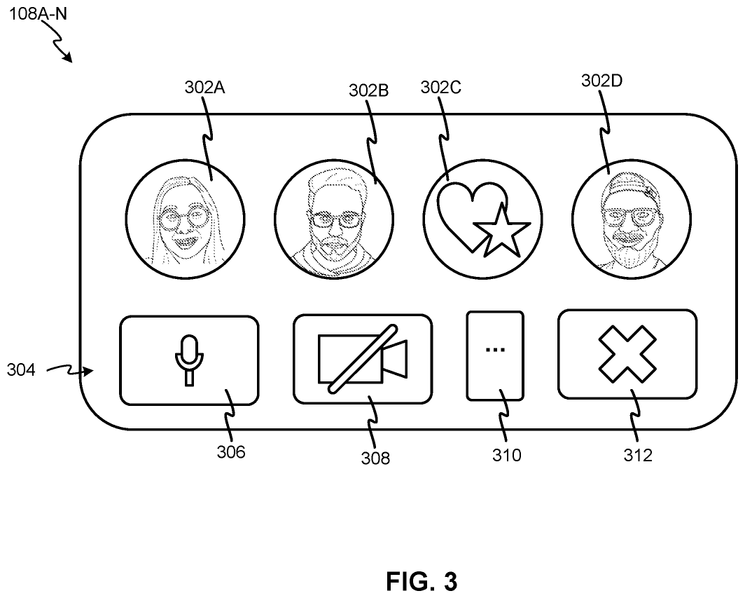

At block 210, processing logic causes a virtual meeting UI to be presented during a virtual meeting 122 between multiple participants. The virtual meeting UI may include multiple regions, and each region can correspond to a participant. The multiple regions may include a first region that corresponds to a first participant. The first region may include a first visual representation that includes an avatar of the first participant. The first visual representation may include a first visual characteristic associated with first participant data of the first participant. An example implementation of the virtual meeting UI with multiple regions and visual representations are shown and explained further below in relation to FIG. 3.

The virtual meeting UI may include the UI 108A-N. The virtual meeting UI can be displayed on a display 107A-N or display device 112 of a client device 102A-N, 104. Each region of the virtual meeting UI can correspond to a virtual meeting participant and may include a visual representation. A visual representation may include an avatar corresponding to a respective participant. The avatar may include an image associated with the participant (e.g., an image of the participant, an image that the participant has selected, etc.). The avatar may include a two-dimensional or three-dimensional character that represents the participant. In some implementations, the visual representation includes a visual characteristic. The visual characteristic may include a shape of the visual representation, a color of the visual representation, a size of the visual representation, or some other visual feature of the visual representation.

In one implementation, the first participant data includes data indicating a characteristic, configuration, or feature of the first participant, the client device 102A-N, 104 of the first participant, or other data associated with the first participant. The first participant data can indicate a virtual meeting 122 role of the first participant. A virtual meeting role may include a host of the virtual meeting 122. The host of the virtual meeting 122 may include the participant that scheduled, initiated, or organized the virtual meeting 122. The host of the virtual meeting 122 may have one or more permissions to manage the virtual meeting 122 that other participants of the virtual meeting 122 may not (e.g., permissions to record the virtual meeting 122, invite participants to the virtual meeting 122, remove participants from the virtual meeting 122, allow participants to share their screen during the virtual meeting 122, etc.). A virtual meeting role may include a co-host of the virtual meeting 122. A co-host of the virtual meeting 122 may have some of the permissions of the host of the virtual meeting 122 or may be able to manage some functionality of the virtual meeting 122 but may not have all of the permissions or functionality as the host. A virtual meeting role may include a general participant, which may include a participant of the virtual meeting 122 that is not a host or co-host.

In one implementation, the first participant data indicates a virtual meeting group to which the first participant belongs. A virtual meeting group may include one or more participants. The host or co-host of the virtual meeting 122 can configure one or more virtual meeting groups and can place participants into the one or more virtual meeting groups. In some implementations, the participants select to which group they belong. The UI controller 134 can configure the UIs 108A-N of the client devices 102A-N, 104 such that the UIs 108A-N only display UI regions corresponding to users in the same virtual meeting group.

In some implementations, a virtual meeting group includes one or more participants from the same organization or entity. For example, the first participant and a second participant may belong to Company A, and a third participant and a fourth participant may belong to Company B. The first participant data and second participant data can indicate that the first participant and the second participant belong to Company A, and third participant data and fourth participant data can indicate that the third participant and the fourth participant belong to Company B. In some implementations, a virtual meeting group includes one or more participants from the same team, section, division, or other group of an organization or entity.

In one or more implementations, the first participant data indicates that a client device 102A of the first participant includes a mobile device, a personal computer, or a virtual meeting media system 110. For example, responsive to the client device 102A of the first participant being a mobile device, the visual representation associated with the first participant may include a certain shape, and responsive to the client device 102B of a second participant being a virtual meeting media system 110, the visual representation associated with the second participant may include a different shape. In one implementation, the first participant data indicates a status of the avatar of the first participant. The status of the avatar may include whether the avatar includes a three-dimensional avatar. In some implementations, the first participant data indicates other information associated with the first participant.

At block 220, processing logic determines that the first participant is a current speaker of the virtual meeting 122. In one implementation, the audio stream processor 133 determines that the audio stream associated with the client device 102A of the first participant is currently providing audio data. The audio data may include audio above a threshold volume level. The audio data may include audio above the threshold volume level that lasts longer than a threshold amount of time. Using a threshold volume level and/or a threshold amount of time can prevent the audio stream processor 133 from incorrectly determining that a participant is a current speaker when the participant's audio, for example, consists of background noise or brief amounts of noise. The audio stream processor 133 can determine that the first participant is a current speaker of the virtual meeting 122 using other operations.

At block 230, processing logic animates the first visual representation to indicate that the first participant is the current speaker of the virtual meeting 122. The first visual representation may include the avatar of the first participant and may have a first visual characteristic. Animating the first visual representation may include modifying the presentation of the first visual representation according to the first visual characteristic. For example, where the first visual characteristic includes a shape of the first visual representation, animating the first visual representation may include presenting the first visual representation as having various different shapes. In one implementation, the first visual representation includes a default shape and a secondary shape. The first visual representation can be displayed in the default shape responsive to the first participant not being a current speaker, and the visual representation can be displayed as alternating between the default shape and the secondary shape responsive to the first participant being a current speaker during the virtual meeting 122. The default shape and/or the secondary shape may be determined based on the first participant data.

At block 240, processing logic determines that the first participant data of the first participant has changed. Determining the first participant data has changed can occur while the first participant is speaking during the virtual meeting 122. In one implementation, the visual representation modification manager 138 periodically analyzes the first participant data to determine if the first participant data has changed. In some implementations, the virtual meeting manager 132 detects a change in the first participant data and notifies the visual representation modification manager 138 of the change.

In some implementations, the first participant data can change responsive to a change of the first participant's virtual meeting role during the virtual meeting 122. For example, the first participant may be a general participant of the virtual meeting 122. The host of the virtual meeting 122 may leave the virtual meeting 122 (e.g., because of network connectivity issues), and the virtual meeting manager 132 can select the first participant as the new host of the virtual meeting 122. In one implementation, the first participant data can change responsive to a change of the first participant's virtual meeting group. For example, the first participant can belong to a first virtual meeting group at a first time during the virtual meeting 122. At a second time occurring after the first time, the host of the virtual meeting 122 can remove the first participant from the first virtual meeting group and place the first participant in a second virtual meeting group.

In one or more implementations, the first participant data can change responsive to the first participant changing the client device 102A-N, 104 by which the first participant participates in the virtual meeting 122. For example, the first participant may initially join the virtual meeting 122 using the client device 104 with the media system 110, which may be located in a conference room. Another meeting may be scheduled for the conference room, which may cause the first participant to stop using the client device 104 and leave the conference room. The first participant can join the virtual meeting 122 from the first participant's client device 102A, which may be a mobile device.

At block 250, processing logic determines, based on the changed first participant data of the first participant, a second visual characteristic for the first visual representation. The second visual characteristic can be different than the first visual characteristic. For example, the first visual characteristic may include a first shape, and the second visual characteristic may include a second shape that is different from the first shape.

At block 260, processing logic causes the first visual representation being animated to have the second visual characteristic to indicate that the first participant is the current speaker of the virtual meeting 122 and that the first participant data has changed. Animating the first visual representation may include modifying the presentation of the first visual representation according to the second visual characteristic. For example, where the second visual characteristic includes a shape of the first visual representation, animating the first visual representation may include presenting the first visual representation as having various different shapes, and the shapes can be different than the shape of the first visual characteristic. In one implementation, the first visual representation includes a default shape and a secondary shape. The first visual representation can be displayed in the default shape responsive to the first participant not being a current speaker, and the visual representation can be displayed as alternating between the default shape and the secondary shape responsive to the first participant being a current speaker during the virtual meeting 122. The default shape and/or the secondary shape can be determined based on the changed first participant data.

In some implementations, the one or more regions of the UI 108A-N further include a second region. The second region can correspond to a second participant of the one or more participants. The second region may include a second visual representation including an avatar of the second participant. The second visual representation may include a third visual characteristic associated with second participant data of the second participant. Similar to the first participant data, the second participant data can indicate one or more characteristics or features of the second participant (e.g., whether the second participant is a host, co-host, or general participant of the virtual meeting 122; a type of client device 102A-N, 104 used by the second participant; etc.). The method 200 can further include processing logic that determines that the second participant is a current speaker of the virtual meeting 122. The processing logic can animate the second visual representation that includes the avatar of the second participant and that has the third visual characteristic to indicate that the second participant is the current speaker of the virtual meeting 122. The third visual characteristic can differ from the first visual characteristic associated with the first participant data of the first participant. In some implementations, the different visual characteristics associated with the respective first participant data or the third participant data visually indicate that the first participant and the third participant have different virtual meeting roles, belong to different virtual meeting groups, are using different types of client devices 102A-N, 104, etc.

FIG. 3 depicts an example UI 108A-N for using dynamic motion of a virtual meeting participant visual representation to indicate an active speaker, in accordance with some implementations of the present disclosure. The UI 108A-N may include one or more visual items 302A-D of one or more UI regions. A visual item 302A-D may include a visual representation that includes an avatar of the participant that corresponds to the respective region. As can be seen in FIG. 3, an avatar may include an image of the respective participant (e.g., 302A, 302B, and 302D) or the avatar may include another type of image (e.g., 302C).

The UI 108A-N may include a tool panel 304. The tool panel 304 may include one or more UI elements (e.g., buttons, visual representations, menus, windows, etc.) to select desired audio features, video features, etc. For example, the tool panel 304 may include an audio button 306 that can mute or unmute the participant and/or a video button 308 that can mute or unmute the participant's video. The tool panel 304 may include an additional options button 310 that can display one or more other virtual meeting options (e.g., options to select one or more operations available to a host if the participant is the host of the virtual meeting 122). The tool panel 304 may include a close button 312 that can cause the participant to disconnect from the virtual meeting 122. As can be seen, each visual representation of a respective visual item 302A-D includes a circle shape as an outline of the visual representation. Responsive to a participant not being a current speaker during the virtual meeting 122, the UI 108A-N can display a visual representation as having the circle shape.

The region that includes the visual item 302A can correspond to a first participant of the virtual meeting 122. The first participant may include first participant data that indicates that the first participant is the host of the virtual meeting 122.

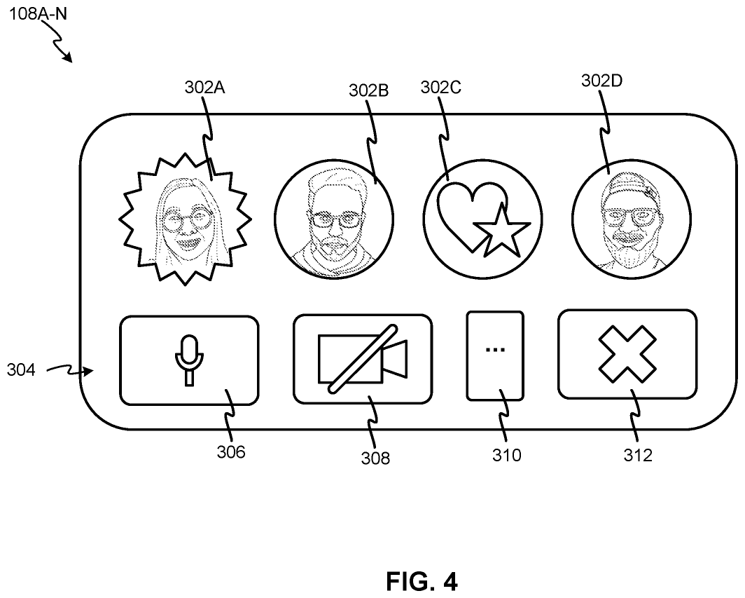

FIG. 4 depicts the example UI 108A-N of FIG. 3 where the UI 108A-N is in the process of using dynamic motion of a virtual meeting participant visual representation to indicate an active speaker, in accordance with some implementations of the present disclosure. As can be seen in FIG. 4, as a result of the first participant being a current speaker of the virtual meeting 122, the first visual representation of the visual item 302A is animated to indicate the first participant is a current speaker. The first visual representation of the first visual item 302A may include a multi-point jagged shape, and animating the first visual representation of the first visual item 302A may include alternating the shape of the first visual representation between the circle shape seen in FIG. 3 and the multi-point jagged shape seen in FIG. 4. The first visual characteristic associated with the first participant data of the first participant may include the multi-point jagged shape.

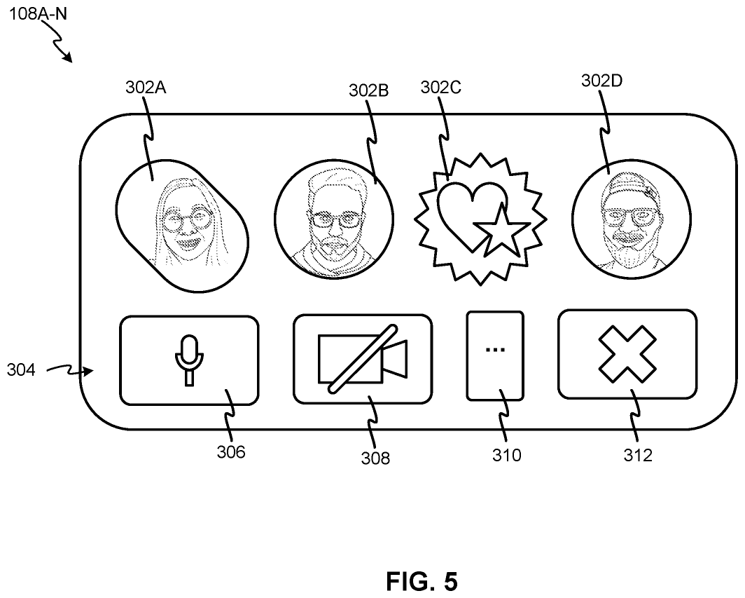

FIG. 5 depicts the example UI 108A-N of FIGS. 3-4 where the UI 108A-N is in the process of using dynamic motion of a virtual meeting participant visual representation to indicate an active speaker, in accordance with some implementations of the present disclosure. In this example, the first participant is associated with the UI region that includes the visual item 302A, and a third participant is associated with the UI region that includes the visual item 302C. The first participant can use an additional option button 310 to change the host of the virtual meeting 122 from the first participant to the third participant. In response, the first participant data can change to indicate that the first participant is not the host, and the third participant data associated with the third participant can change to indicate that the third participant is the host. In response, the visual representation modification manager 138 can determine the change in the first participant data, and the visual representation modification manager 138 can determine a second visual characteristic for the first visual representation. The second visual characteristic may include a slanted oblong shape, as can be seen in relation to the first visual item 302A in FIG. 5. Causing the first visual representation to be animated to have the second visual characteristic in block 260 may include alternating the shape of the first visual representation between the circle shape seen in FIG. 3 and the slanted oblong shape. This can indicate that the first participant is a current speaker and that the first participant is a general participant (e.g., no longer the host).

As can also be seen in FIG. 5, the third visual representation of the third visual item 302C associated with the third participant can be animated to have the first visual characteristic. Animating the third visual representation according to the first visual characteristic may include alternating the shape of the third visual representation between the circle shape and the multi-point jagged shape. This can visually indicate that the third participant is a current speaker and is the host of the virtual meeting 122.

Referring back to FIG. 2, in some implementations, one or more blocks of the method 200 occur at a preparation phase of the virtual meeting 122. The preparation phase may include a presentation of a UI 108A-N of the application 105A that allows the participant to prepare to enter the virtual meeting 122. While in the preparation phase, the audio stream processor 133 may not stream audio from the first participant's client device 102A to one or more other client devices 102B-N, 104, and the video stream processor 135 may not stream video from the first participant's client device 102A to one or more other client devices 102B-N, 104. The application 105A may not stream video or audio to the virtual meeting platform 120, the server 130, or to one or more other client devices 102B-N, 104. The preparation phase can allow the participant to adjust audio or microphone levels or perform other virtual meeting 122 preparation tasks. The preparation phase can allow the visual representation modification manager 138 to determine the first visual characteristic associated with the first participant data, identify the first participant data, or perform other tasks in order to determine the visual characteristic. The preparation phase can allow the first participant to speak into a microphone of the first participant's client device 102A and view the animation of the first visual representation in order to test the animation of the first visual representation before entering a live phase of the virtual meeting 122.

In some implementations, determining the second visual characteristic for the first visual representation is further based on user input obtained from a client device 102A of the first participant at a virtual meeting preparation phase of the virtual meeting 122. For example, at the virtual meeting preparation phase, the UI 108A of the client device 102 of the first participant can present a menu that includes multiple shapes. The first participant can provide user input to select a shape to use as the first visual characteristic, the second visual characteristic, or some other visual characteristic. In some implementations, the first participant can select which visual characteristic (e.g., visual representation shape) corresponds to different participant data (e.g., participant data indicating different virtual meeting roles, virtual meeting groups, client device types, etc.).

In one or more implementations, causing the first visual representation to periodically alternate between the first visual characteristic and the second visual characteristic occurs during a live phase of the virtual meeting 122. A live phase can refer to a phase in which virtual meeting participants are able to interact with each other (e.g., view or hear each other in real-time (or near real-time due to transmission delays, etc.) during the virtual meeting 122). This may include the client devices 102A-N, 104 providing their respective audio streams to the server 130 or to each other.

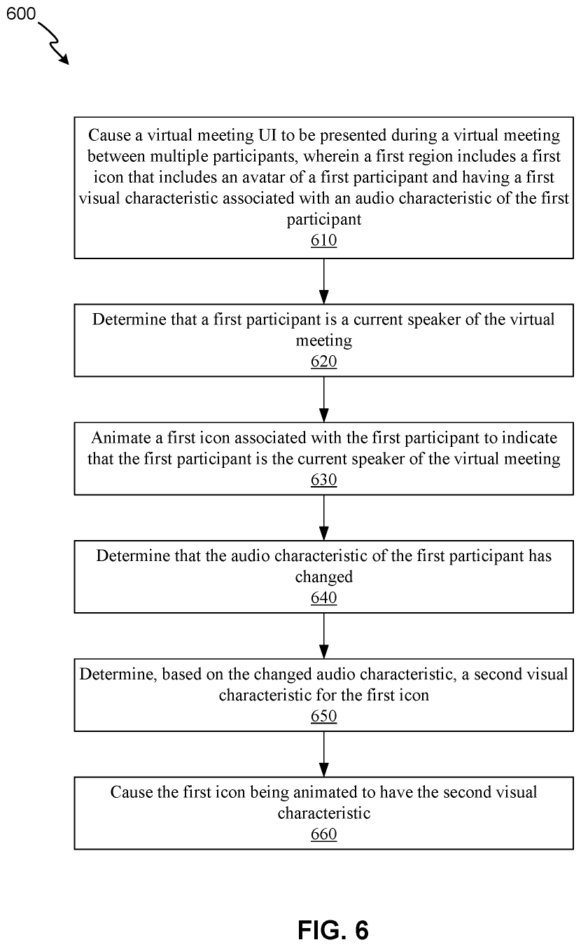

FIG. 6 is a flowchart illustrating one embodiment of a method 600 for using dynamic motion of a virtual meeting participant visual representation to indicate an active speaker, in accordance with some implementations of the present disclosure. A processing device, having one or more CPU(s), one or more GPU(s), and/or memory devices communicatively coupled to the one or more CPU(s) and/or GPU(s) can perform the method 600 and/or one or more of the method's 600 individual functions, routines, subroutines, or operations. In certain implementations, a single processing thread can perform the method 600. Alternatively, two or more processing threads can perform the method 600, each thread executing one or more individual functions, routines, subroutines, or operations of the method. In an illustrative example, the processing threads implementing the method 600 can be synchronized (e.g., using semaphores, critical sections, and/or other thread synchronization mechanisms). Alternatively, the processing threads implementing the method 600 can be executed asynchronously with respect to each other. Various operations of the method 600 can be performed in a different (e.g., reversed) order compared with the order shown in FIG. 6. Some operations of the method 600 can be performed concurrently with other operations. Some operations can be optional. In some implementations, the audio stream processor 133, the UI controller 134, the video stream processor 135, or the visual representation modification manager 138 performs one or more of the operations of the method 600.

At block 610, processing logic causes a virtual meeting UI 108A-N to be presented during a virtual meeting between one or more participants. The virtual meeting UI 108A-N may include one or more regions, and each region can correspond to a participant of the virtual meeting 122. The one or more regions may include a first region corresponding to a first participant. The first region may include a first visual representation that includes an avatar of the first participant. The first visual representation may include a first visual characteristic associated with an audio characteristic of the first participant. Block 610 may include functionality similar to the functionality of block 210 of the method 200 of FIG. 2.

In some implementations, the audio characteristic of the first participant includes a vocal emphasis. A vocal emphasis may include an amount of stress used when speaking a sound, syllable, word, or other part of speech. The audio characteristic may include a vocal intonation. A vocal intonation may include a rising or falling pitch used when speaking a sound, syllable, word, or other part of speech. The audio characteristic may include a vocal pitch. A vocal pitch may include a sonic frequency used when speaking a sound, syllable, word, or other part of speech.

In one or more implementations, the audio stream processor 133 or the visual representation modification manager 138 determines the audio characteristic of the first participant. For example, the audio stream processor 133 can obtain an audio stream from the client device 102A of the first participant and can analyze the audio stream to determine the audio characteristic.

At block 620, processing logic determines that the first participant is a current speaker of the virtual meeting. Block 620 may include functionality similar to the functionality of block 220 of the method 200.

At block 630, processing logic animates the first visual representation to indicate that the first participant is the current speaker of the virtual meeting 122. Block 630 may include functionality similar to the functionality of block 230 of the method 200.

At block 640, processing logic determines that the audio characteristic of the first participant has changed. Determining the change in the audio characteristic can occur while the first participant is speaking during the virtual meeting 122. Determining the change in the audio characteristic may include determining that the first participant used vocal emphasis after not using vocal emphasis, or vis versa. For example, the first participant can speak one or more words without using vocal emphasis and then speak a word with emphasis. Determining the change in the audio characteristic may include determining that the first participant used vocal intonation after not using vocal intonation, or vis versa. For example, the first participant can speak one or more words without using vocal intonation and then speak the last word of a sentence with a rising intonation (e.g., to indicate that the sentence is a question). Determining the change in the audio characteristic may include determining that the first participant changed vocal pitch. For example, the first participant can speak one or more words at a first pitch and then speak one or more words afterwards at a second pitch.

At block 650, processing logic determines, based on the changed audio characteristic of the first participant, a second visual characteristic for the first visual representation. Block 640 may include functionality similar to the functionality of block 250 of the method 200.

At block 660, processing logic causes the first visual representation being animated to have the second visual characteristic to indicate that the first participant is the current speaker of the virtual meeting and that the audio characteristic has changed. Block 660 may include functionality similar to the functionality of block 260 of the method 200.

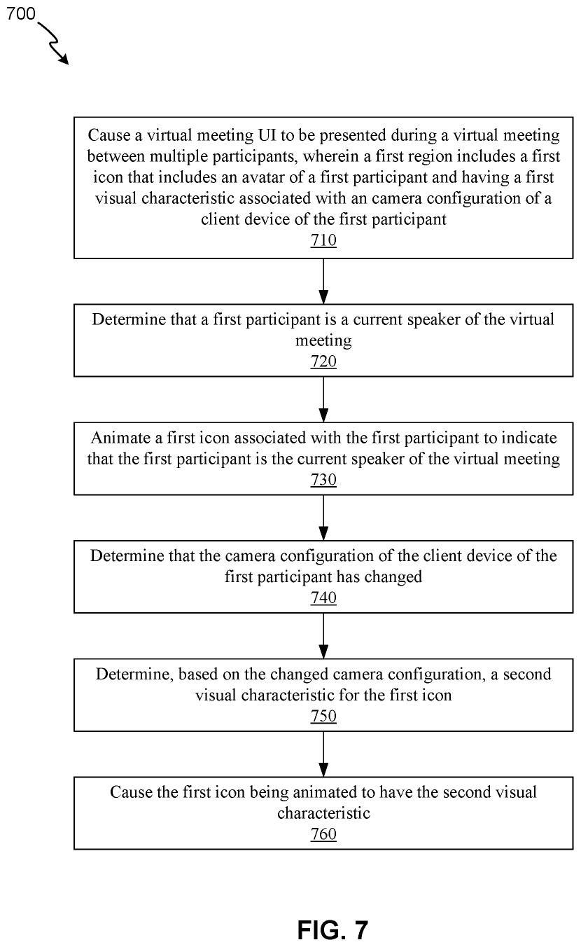

FIG. 7 is a flowchart illustrating one embodiment of a method 700 for using dynamic motion of a virtual meeting participant visual representation to indicate an active speaker, in accordance with some implementations of the present disclosure. A processing device, having one or more CPU(s), one or more GPU(s), and/or memory devices communicatively coupled to the one or more CPU(s) and/or GPU(s) can perform the method 700 and/or one or more of the method's 700 individual functions, routines, subroutines, or operations. In certain implementations, a single processing thread can perform the method 700. Alternatively, two or more processing threads can perform the method 700, each thread executing one or more individual functions, routines, subroutines, or operations of the method. In an illustrative example, the processing threads implementing the method 700 can be synchronized (e.g., using semaphores, critical sections, and/or other thread synchronization mechanisms). Alternatively, the processing threads implementing the method 700 can be executed asynchronously with respect to each other. Various operations of the method 700 can be performed in a different (e.g., reversed) order compared with the order shown in FIG. 7. Some operations of the method 700 can be performed concurrently with other operations. Some operations can be optional. In some implementations, the audio stream processor 133, the UI controller 134, the video stream processor 135, or the visual representation modification manager 138 performs one or more of the operations of the method 700.

At block 710, processing logic causes a virtual meeting UI 108A-N to be presented during a virtual meeting between one or more participants. The virtual meeting UI 108A-N may include one or more regions, and each region can correspond to a participant of the virtual meeting 122. The one or more regions may include a first region corresponding to a first participant. The first region may include a first visual representation that includes an avatar of the first participant. The first visual representation may include a first visual characteristic associated with a camera configuration of a client device 102A of the first participant. Block 710 may include functionality similar to the functionality of block 210 of the method 200 of FIG. 2.

In some implementations, the camera configuration of the client device 102A of the first participant includes whether a camera of the client device 102A is in an unmuted state or in a muted state. The camera being unmuted may include the camera providing a video stream to the video stream processor 135 or one or more of the other client devices 102B-N, 104. The camera being muted may include the camera not providing a video stream to the video stream processor 135 or one or more of the other client devices 102B-N, 104. The camera configuration may include some other configuration or status of the camera of the client device 102A.

At block 720, processing logic determines that the first participant is a current speaker of the virtual meeting. Block 720 may include functionality similar to the functionality of block 220 of the method 200.

At block 730, processing logic animates the first visual representation to indicate that the first participant is the current speaker of the virtual meeting 122. Block 730 may include functionality similar to the functionality of block 230 of the method 200.

At block 740, processing logic determines that the camera configuration of the first participant has changed. Determining the change in the camera configuration can occur while the first participant is speaking during the virtual meeting 122. Determining the change in the configuration may include the video stream processor 135 obtaining a video stream from the client device 102A of the first participant or the video stream processor 135 ceasing to obtain the video stream from the client device 102A of the first participant. Determining the change in the configuration may include some other operation. The video stream processor 135 can provide indication of the change of camera configuration to the visual representation modification manager 138.

At block 750, processing logic determines, based on the changed camera configuration of the client device 102A of the first participant, a second visual characteristic for the first visual representation. Block 740 may include functionality similar to the functionality of block 250 of the method 200.

At block 760, processing logic causes the first visual representation being animated to have the second visual characteristic to indicate that the first participant is the current speaker of the virtual meeting and that the camera configuration has changed. Block 760 may include functionality similar to the functionality of block 260 of the method 200.

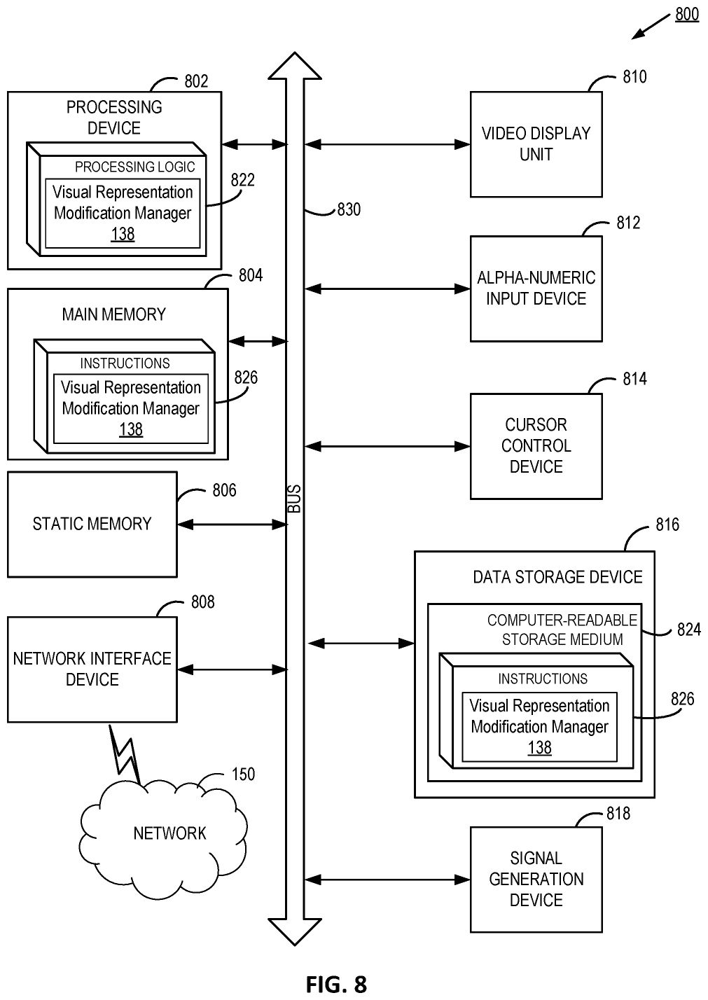

FIG. 8 is a block diagram illustrating an example computer system 800, in accordance with implementations of the present disclosure. The computer system 800 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 816, which communicate with each other via a bus 830.

The processing device 802 represents one or more general-purpose processing devices such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute the processing logic 822 for performing the operations discussed herein (e.g., one or more of the operations of the methods 200, 600, or 700).

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (sometimes referred to as a “computer-readable storage medium”) on which is stored one or more sets of instructions 826 (e.g., the instructions to carry out one or more operations of the methods 200, 600, or 700) embodying any one or more of the methodologies or functions described herein. The instructions can also reside, completely or at least partially, within the main memory 804 and/or within the processing device 802 during execution thereof by the computer system 800, the main memory 804 and the processing device 802 also constituting machine-readable storage media. The instructions can further be transmitted or received over the network 150 via the network interface device 808.

In one implementation, the instructions 826 include instructions for determining visual items for presentation in a user interface of a virtual meeting. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method, comprising:
causing a virtual meeting user interface (UI) to be presented during a virtual meeting between a plurality of participants, the virtual meeting UI comprising a plurality of regions each corresponding to a participant of the plurality of participants, wherein:
the plurality of regions comprises a first region corresponding to a first participant of the plurality of participants, and
the first region comprises a first visual representation including an avatar of the first participant, the first visual representation having a first visual characteristic associated with first participant data of the first participant;
determining that the first participant is a current speaker of the virtual meeting;
animating the first visual representation to indicate that the first participant is the current speaker of the virtual meeting;
determining, while the first participant is speaking during the virtual meeting, that the first participant data of the first participant has changed;
determining, based on the changed first participant data of the first participant, a second visual characteristic for the first visual representation; and
causing the first visual representation being animated to have the second visual characteristic to indicate that the first participant is the current speaker of the virtual meeting and that the first participant data has changed.

2. The method of claim 1, wherein the first participant data indicates a virtual meeting role of the first participant.

3. The method of claim 1, wherein the first participant data indicates a virtual meeting group associated with the first participant.

4. The method of claim 1, wherein the first participant data indicates that a client device of the first participant comprises at least one of:
a mobile device;
a personal computer; or
a virtual meeting media system.

5. The method of claim 1, wherein the first participant data indicates a status of the avatar of the first participant.

6. The method of claim 1, wherein the first visual characteristic comprises a shape of the first visual representation.

7. The method of claim 1, wherein the first visual characteristic comprises at least one of a color of the first visual representation or a size of the first visual representation.

8. The method of claim 1, wherein:
the plurality of regions further comprises a second region corresponding to a second participant of the plurality of participants, and wherein the second region comprises a second visual representation including an avatar of the second participant, the second visual representation having a third visual characteristic associated with second participant data of the second participant;
determining that the second participant is the current speaker of the virtual meeting; and
animating the second visual representation including the avatar of the second participant and having the third visual characteristic to indicate that the second participant is the current speaker of the virtual meeting.

9. The method of claim 8, wherein the third visual characteristic differs from the first visual characteristic.

10. A method, comprising:
causing a virtual meeting user interface (UI) to be presented during a virtual meeting between a plurality of participants, the virtual meeting UI comprising a plurality of regions each corresponding to a participant of the plurality of participants, wherein:
the plurality of regions comprises a first region corresponding to a first participant of the plurality of participants, and
the first region comprises a first visual representation including an avatar of the first participant, the first visual representation having a first visual characteristic associated with an audio characteristic of the first participant;
determining that the first participant is a current speaker of the virtual meeting;
animating the first visual representation including the avatar of the first participant and having the first visual characteristic to indicate that the first participant is the current speaker of the virtual meeting;
determining, while the first participant is speaking during the virtual meeting, that the audio characteristic of the first participant has changed;
determining, based on the changed audio characteristic of the first participant, a second visual characteristic for the first visual representation; and
causing the first visual representation being animated to have the second visual characteristic to indicate that the first participant is the current speaker of the virtual meeting and that the audio characteristic has changed.

11. The method of claim 10, wherein the audio characteristic comprises a vocal emphasis.

12. The method of claim 10, wherein the audio characteristic comprises a vocal intonation.

13. The method of claim 10, wherein the audio characteristic comprises a vocal pitch.

14. The method of claim 10, wherein the first visual characteristic comprises a shape of the first visual representation.

15. The method of claim 10, wherein the first visual characteristic comprises at least one of a color of the first visual representation or a size of the first visual representation.

16. The method of claim 10, wherein:
determining the second visual characteristic for the first visual representation is further based on user input obtained from a client device of the first participant at a virtual meeting preparation phase of the virtual meeting; and
causing the first visual representation to periodically alternate between the first visual characteristic and the second visual characteristic occurs during a live phase of the virtual meeting.

17. A method, comprising:
causing a virtual meeting user interface (UI) to be presented during a virtual meeting between a plurality of participants, the virtual meeting UI comprising a plurality of regions each corresponding to a participant of the plurality of participants, wherein:
the plurality of regions comprises a first region corresponding to a first participant of the plurality of participants, and
the first region comprises a first visual representation including an avatar of the first participant, the first visual representation having a first visual characteristic associated with a camera configuration of a client device of the first participant;
determining that the first participant is a current speaker of the virtual meeting;
animating the first visual representation including the avatar of the first participant and having the first visual characteristic to indicate that the first participant is the current speaker of the virtual meeting;
determining, while the first participant is speaking during the virtual meeting, that the camera configuration has changed;
determining, based on the changed camera configuration, a second visual characteristic for the first visual representation; and
causing the first visual representation being animated to have the second visual characteristic to indicate that the first participant is the current speaker of the virtual meeting and that the camera configuration has changed.

18. The method of claim 17, wherein the camera configuration of the client device of the first participant comprises a camera of the client device being in an unmuted state.

19. The method of claim 17, wherein the camera configuration of the client device of the first participant comprises a camera of the client device being in a muted state.

20. The method of claim 17, wherein the first visual characteristic comprises a shape of the first visual representation.
